(19) United States
(12) Patent Application Publication
(10) Pub. No.: US 2026/0200452 A1
(43) Pub. Date: Jul. 16, 2026

(54) METHOD FOR CONTROLLING AN ELECTROMECHANICAL VEHICLE BRAKE

(71) Applicant: Robert Bosch GmbH, Stuttgart (DE)

(72) Inventors: Xun Yao, Beilstein (DE); Herbert Vollert, Vaihingen/Enz (DE); Lisa Kurz, Heilbronn (DE)

(21) Appl. No.: 19/430,702

(22) Filed: Dec. 23, 2025

(30) Foreign Application Priority Data
Jan. 14, 2025 (DE) 10 2025 101 030.7

(51) Int. Cl. B60T 17/22; B60T 8/171; B60T 8/172; B60T 13/74; G07C 5/08

(52) U.S. Cl. CPC B60T 17/22; B60T 8/171; B60T 8/172; B60T 13/746; G07C 5/0808; G07C 5/0816; B60T 2270/406

(57) ABSTRACT

A method for controlling an electromechanical vehicle brake, including a first brake body, a second brake body, and an electromechanical actuator. The method includes: carrying out a diagnostic step in which the actuator is controlled to move in a first direction with a force that is limited in comparison to a maximum possible force and in which the distance traveled is used to ascertain whether the vehicle brake is malfunctioning; if the diagnostic step reveals that the vehicle brake is malfunctioning, carrying out a malfunction identification step in which the actuator is controlled in a second direction opposite to the first direction with maximum force and in which the distance traveled is used to ascertain whether the vehicle brake is malfunctioning due to icing; and, if the malfunction identification step reveals a malfunction due to icing, carrying out a deicing step.

### CROSS REFERENCE

The present application claims the benefit under 35 U.S.C. § 119 of Germany Patent Application No. DE 10 2025 101 030.7 filed on Jan. 14, 2025, which is expressly incorporated herein by reference in its entirety.

### FIELD

The present invention relates to a method for controlling an electromechanical vehicle brake.

### BACKGROUND INFORMATION

Electromechanical vehicle brakes have recently gained importance. Unlike conventional hydraulic vehicle brakes, electromechanical vehicle brakes make the generation of a wheel-specific braking force possible.

As is the case for hydraulic vehicle brakes, low outside temperatures can impair the functionality of electromechanical vehicle brakes; in particular if an electromechanical actuator of the electromechanical vehicle brake ices up. This can result in decreased braking power, overheating of the brake or increased wear of the brake or other components, for instance.

### SUMMARY

An object of the present invention is to provide a method for controlling an electromechanical vehicle brake and an electromechanical vehicle brake system with which icing of the electromechanical vehicle brake can be detected and rectified.

In a first aspect of the present invention, this object is achieved by a method for controlling an electromechanical vehicle brake comprising a first brake body, a second brake body and an electromechanical actuator, wherein the actuator is configured to bring the first brake body into contact with the second brake body in order to produce a braking effect and to release the first brake body from the second brake body in order to terminate the braking effect. According to an example embodiment of the present invention, the method comprises:
carrying out a diagnostic step in which the actuator is controlled to move in a first direction with a force that is limited in comparison to a maximum force and in which the distance traveled is used to ascertain whether the vehicle brake is malfunctioning,
if the diagnostic step reveals that the vehicle brake is malfunctioning, carrying out a malfunction identification step in which the actuator is controlled in a second direction opposite to the first direction with maximum force and in which the distance traveled is used to ascertain whether the vehicle brake is malfunctioning due to icing, and,
if the malfunction identification step reveals a malfunction due to icing, carrying out a deicing step in which the actuator is controlled to move in the first direction with force that is limited compared to the maximum force.

According to an example embodiment of the present invention, the electromechanical actuator can comprise an electric motor, for example, and also a rotation-translation gear configured to convert a rotational movement of a shaft of the electric motor into a translational movement. The translational movement can be used to move the first brake body toward or away from the second brake body. The first brake body can be configured as a brake pad, for example, and the second brake body can be configured as a brake disc.

A force with which the actuator is actuated can be controlled via electrical power supplied to the actuator, for example the electric motor. A maximum force thus corresponds to the maximum electrical power that can be supplied to the actuator.

The distance traveled can be a change in the rotational position of a shaft of the electric motor or a spindle of the rotation-translation gear, a distance traveled by a nut of the rotation-translation gear connected in a rotationally fixed manner to a housing, or a displacement of the first brake body. The distance traveled can be ascertained using a respective position sensor. The distance traveled can be ascertained after each actuation of the actuator with a predetermined amount of electrical power for a predetermined period of time. In other words, a predetermined amount of electrical power is supplied to the actuator for a predetermined time interval, and then the distance traveled by the actuator within this predetermined time interval is ascertained.

In the method of the present invention, a simple comparison of the distance traveled with respective threshold values can be used to ascertain whether the vehicle brake is malfunctioning and whether the malfunction is due to ice formation on the actuator or the brake bodies. If it is determined that the malfunction is due to icing, the ice can be removed by another defined movement of the actuator, i.e. without any additional measures.

To be able to detect a malfunction, the travel distance during the actuation of the actuator can be compared in the diagnostic step with a first threshold value, which can be set in advance. If the comparison shows that the travel distance is shorter than the first threshold value, it can be assumed that there is a malfunction in the vehicle brake.

In the subsequent malfunction identification step, it can then be ascertained what type of malfunction it is, i.e. whether the vehicle brake is iced up or whether there is another reason for the malfunction, for instance mechanical jamming or an electrical problem.

According to an example embodiment of the present invention, in the malfunction identification step, it can be determined that there is a malfunction due to icing if the distance traveled in the malfunction identification step is longer than a second threshold value that is less than the first threshold value and that there is a malfunction that is not due to icing if the distance traveled in the malfunction identification step is shorter than the second threshold value. These criteria are based on the fact that, in the event of icing, the actuator can be controlled electrically and the ice that has formed allows the first brake body to move at least within a narrow range. Therefore, if the distance traveled is shorter than the first threshold value but longer than the second threshold value, a malfunction due to icing is assumed.

If the distance traveled is shorter than the second threshold value, however, it can be assumed that either the actuator cannot be controlled or there is another mechanical problem that does not allow significant displacement of the first brake body even when the actuator is controlled with maximum force. In that case, it can be assumed that the problem cannot be resolved without a more in-depth investigation, which can only be carried out in a specialist workshop, for example. In such a case, a corresponding warning can be output to the driver to initiate such an investigation.

On the other hand, if the malfunction identification step reveals a malfunction due to icing, an attempt is made to resolve the malfunction by moving the actuator in the first direction to save time and avoid additional costs. After the deicing step, it can be checked whether the distance traveled during the deicing step, i.e. the distance traveled after the actuator was actuated for a specified period of time, is longer than the first threshold value.

If the distance traveled exceeds the first threshold value, it can be assumed that the deicing was successful. However, if the distance traveled is shorter than the first threshold value, it is assumed that the deicing has not yet been successful. The malfunction identification step can therefore then be carried out again.

The malfunction identification step and the deicing step can be carried out cyclically a predetermined number n1 of times unless one of the following conditions occurs:
during an nth execution of the malfunction identification step it is determined that the distance traveled during the execution of the nth malfunction identification step is shorter than the second threshold value, wherein n is less than or equal to n1, and
after the nth execution of the deicing step it is determined that the distance traveled during the execution of the nth deicing step is greater than the first threshold value, wherein n is less than n1.

This means that the method executes a loop in which the malfunction identification step, the deicing step, and the comparison of the distance traveled with the first threshold value are carried out sequentially and cyclically. The execution of the loop is interrupted if a malfunction is detected during a specific execution of the malfunction identification step that does not indicate icing, or if deicing was successful.

However, if after the n1st execution of the deicing step it is determined that the distance traveled during the execution of the n1st deicing step is still shorter than the first threshold value, a warning can be output to the driver prompting them to have the vehicle inspected at a specialist workshop. The method can then also be terminated.

The method can include a temperature acquisition step at the beginning, in which an outside temperature is acquired that can be used to assess whether icing is possible.

The object defined at the outset is achieved in a second aspect of this disclosure by an electromechanical vehicle brake system including: an electromechanical vehicle brake comprising: a first brake body, a second brake body and an electromechanical actuator, wherein the actuator is configured to bring the first brake body into contact with the second brake body in order to produce a braking effect and to release the first brake body from the second brake body in order to terminate the braking effect, and a control device configured to control the electromechanical vehicle brake according to an above-described method.

A vehicle comprising an above-described electromechanical vehicle brake system is provided according to the present invention as well.

The present invention is explained in more detail in the following with reference to the figures.

### BRIEF DESCRIPTION OF THE DRAWINGS

FIG. 1 is a schematic illustration of an electromechanical vehicle brake, according to an example embodiment of the present invention.

FIG. 2 shows a flow chart of an example of a method for controlling the vehicle brake shown in FIG. 1, according to an example embodiment of the present invention.

FIG. 3 shows different characteristic curves that are characteristic of respective states of the electromechanical vehicle brake shown in FIG. 1, according to an example embodiment of the present invention.

### DETAILED DESCRIPTION OF EXAMPLE EMBODIMENTS

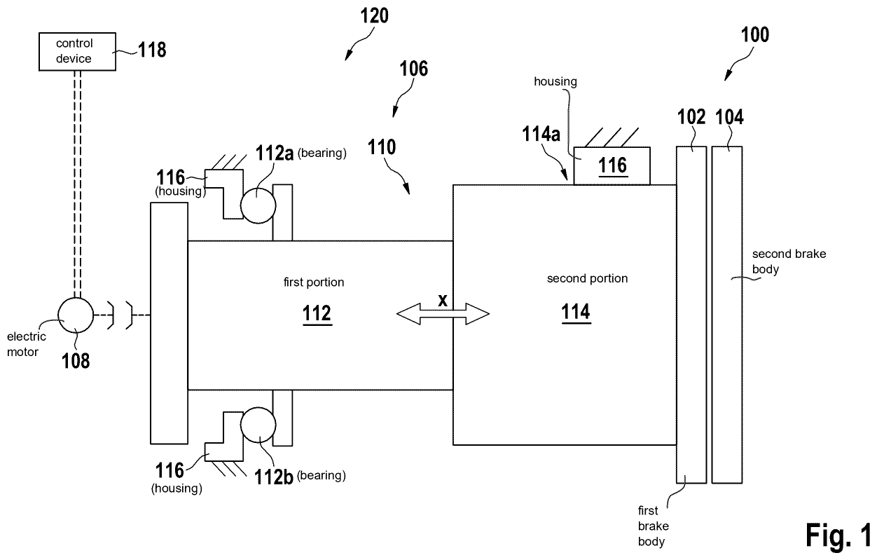

FIG. 1 is a schematic illustration of an electromechanical vehicle brake 100. The vehicle brake 100 comprises a first brake body 102, a second brake body 104 and an electromechanical actuator 106, wherein the actuator is configured to bring the first brake body 102 into contact with the second brake body 104 in order to produce a braking effect and to release the first brake body 102 from the second brake body 104 in order to terminate the braking effect. The first brake body 102 can be a brake pad, for example, and the second brake body 104 can be a brake disc.

The electromechanical actuator 106 can comprise: an electric motor 108 and also a rotation-translation gear 110 configured to convert a rotational movement provided by the electric motor 108 into a translational movement by means of which the first brake body 102 can be moved toward or away from the second brake body 104.

The rotation-translation gear 110 can include a first portion 112 which can be rotated by the electric motor 108 and a second portion 114 that can be translationally displaced along the direction indicated by the arrow x. The first portion 112 can be rotatably supported on a housing 116 via bearings 112a, 112b. The second portion 114 can be connected to the housing 116 in a rotationally fixed manner and mounted such that it can be moved relative to the housing 116.

The electric motor 108 can be controlled by a control device 118. The electromechanical vehicle brake 100 and the control device 118 form an electromechanical brake system 120.

In a disturbance-free state, the second portion 114, which is connected to the first brake body 102, is moved by the electric motor 108 along the direction x toward the second brake body 104 to provide a clamping force (braking force) or away from it to release the clamping force.

The second portion 114 is in contact with the housing 116 at the position indicated by the reference sign 114a. At low temperatures below freezing, icing can occur at this location, as a result of which the frictional force acting at this location can lead to excessive frictional resistance between the second portion 114 and the housing 116. This can lead to excessive stress on other components of the vehicle brake 100, such as the second portion 112 at the position of the bearings 112a, 112b.

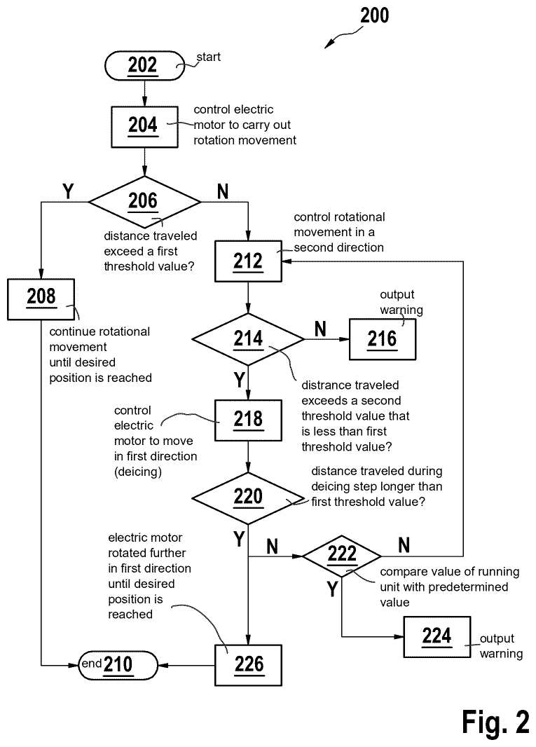

FIG. 2 shows a flow chart of an example of a method 200 that can be used to detect and rectify a malfunction due to icing.

After the start 202 of the method 200, the electric motor 108 is controlled to carry out a rotational movement in a first direction with force that is limited compared to a maximum possible (maximum) force for a predetermined time interval (in 204). In step 204, a running index n, which will be discussed in more detail later, is also set to zero (n=0). Then, it is checked (in 206) whether the distance traveled by the electric motor 108, which can be ascertained by means of a rotor bearing sensor, for example, exceeds a first threshold value s1. If the distance traveled exceeds the first threshold value s1, the vehicle brake 100 is assumed to be functioning properly and the method 200 proceeds along the path marked “Y” in FIG. 2 to step 208, in which the rotational movement of the electric motor 108 is continued until it reaches a desired position. The method 200 is then terminated (at 210).

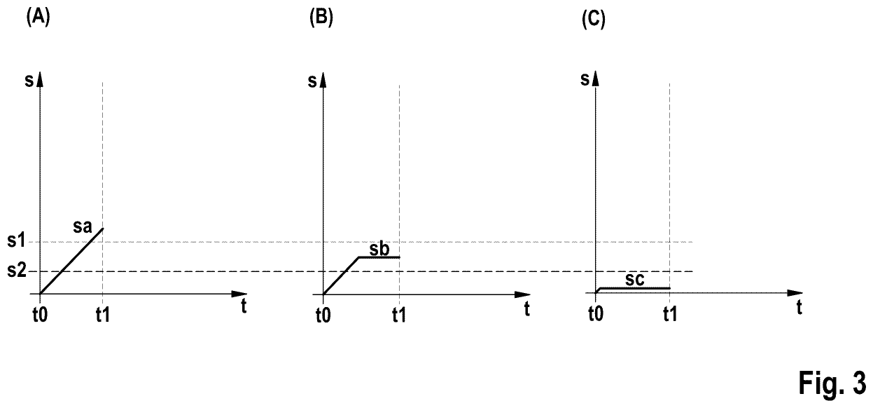

Fault-free operation of the vehicle brake 100 is characterized by a linear increase in the distance traveled of the electric motor 108 during a predetermined time interval in which electrical power is supplied to the electric motor 108 as shown in the t (time)-s (distance) diagram marked “(A)” in FIG. 3. This allows the distance traveled sa to exceed the threshold value s1 after the electric motor 108 has been controlled with a predetermined amount of electrical power in the time interval between the points in time t0 and t1.

On the other hand, if step 206 reveals that the distance traveled is less than the first threshold value s1, it is assumed that the vehicle brake 100 is malfunctioning. Steps 204 and 206 are therefore used to ascertain whether or not there is a malfunction. These two steps 204, 206 can thus be considered together as a diagnostic step.

If a malfunction is detected in the diagnostic step, the method 200 proceeds along the path marked “N” to step 212 in which the electric motor 108 is controlled in a second direction opposite to the first direction with maximum force. In this step 212, the running index n is also increased by 1(n=n+1 ).

In step 214, it is then ascertained whether the distance traveled exceeds a second threshold value s2 that is less than the first threshold value s1. If the distance traveled is greater than the second threshold value s2, it is determined that there is icing. On the other hand, if it is found that the distance traveled is less than the second threshold value s2, it is determined that there is a fault that cannot be attributed to icing.

The temporal progressions of the distances traveled sb or sc in the event of a malfunction are shown in the diagrams labeled “(B)” and “(C)” in FIG. 3. In diagram (B), the distance traveled sb at the time t1, i.e. after the electric motor has been actuated in the time interval between t0 and t1, lies between the first threshold value s1 and the second threshold value s2. Since a certain, albeit limited, distance has been traveled here, it is assumed that there is icing of the actuator 106, for example at position 114a, because in such a case the actuator 106 can travel the limited distance due to its elastic behavior.

In diagram (C) of FIG. 3, the distance traveled sc is less than the second threshold value s2, which indicates a fault that cannot be attributed to icing, for example a serious mechanical fault or an electrical fault that impairs the control of the electric motor 108.

Since the malfunction is identified in both steps 212 and 214, these two steps 212 and 214 together are referred to as the malfunction identification step.

If step 214 reveals that the distance traveled is less than the second threshold value s2, the method 200 proceeds along the path marked “N” to step 216 in which a warning is output informing the driver that the vehicle brake 100 has a fault that should be investigated further at a specialist workshop.

On the other hand, if step 214 reveals that the distance traveled is greater than the second threshold value s2, the method 200 proceeds along the path marked “Y” to step 218, in which the electric motor is controlled to move in the first direction with force that is limited compared to the maximum possible force. This step is referred to hereinafter as the deicing step.

Here, an attempt is made to resolve the malfunction by moving the electric motor 108 in the first direction. After the deicing step 218, the following step 220 can be used to check whether the distance traveled during the deicing step 218 is longer than the first threshold value s1.

If the distance traveled is longer than the first threshold value s1, it can be assumed that the deicing was successful. The method 200 then proceeds along the path marked “Y” to step 226, in which the electric motor 108 is rotated further in the first direction until a desired end position is reached. The method can then be terminated (in 210).

However, if step 220 reveals that the distance traveled is shorter than the first threshold value s1, it is assumed that the deicing has not yet been successful. The malfunction identification step 212, 214 can therefore then be carried out again.

The malfunction identification step 212, 214 and the deicing step 218 can be carried out cyclically a predetermined number n1 of times unless one of the following conditions occurs:

Condition 1: during an nth execution of the malfunction identification step 212, 214 it is determined that the distance traveled during the execution of the nth malfunction identification step 212, 214 is shorter than the second threshold value s2, wherein n is less than or equal to n1. If the distance traveled is shorter than the second threshold value s2, it is assumed, as described above, that there is a serious electrical or mechanical fault, and the method proceeds to step 216 and is then terminated.

Condition 2: after the nth execution of the deicing step 218 it is determined that the distance traveled during the execution of the nth deicing step is greater than the first threshold value s1, (n less than n1). In this case, the deicing is assumed to have been successful. The method then proceeds to step 226 as described above and is subsequently terminated.

Before the malfunction identification step 212, 214 is repeated after an unsuccessful deicing step 218, the value of the running index n is first compared with the predetermined value n1 in step 222 to ensure that the cyclic repetition of the malfunction identification step 212, 214 and the deicing step 218 is only carried out a predetermined number n1 of times.

If step 222 reveals that n is equal to n1 (n=n1), the method 200 proceeds to step 224 in which a warning is output informing the driver that a serious fault has occurred. The method can then be terminated.

On the other hand, if step 222 reveals that n is less than n1 (n<n1), the method 200 proceeds via the path marked “N” to step 212, in which the running index n is increased by 1, thereby reducing the number of remaining repetitions of the malfunction identification step 212, 214 and the deicing step 218 by 1.

The method can also include a temperature acquisition step in which an outside temperature is ascertained. This makes it possible to check whether icing of the actuator 106 is possible.

A vehicle comprising an above-described electromechanical vehicle brake system 120 is provided as well.

What is claimed is:

1. A method for controlling an electromechanical vehicle brake, the vehicle brake including a first brake body, a second brake body, and an electromechanical actuator, wherein the actuator is configured to bring the first brake body into contact with the second brake body to produce a braking effect and to release the first brake body from the second brake body to terminate the braking effect, wherein the method comprises the following steps:
carrying out a diagnostic step in which the actuator is controlled to move in a first direction with a force that is limited in comparison to a maximum possible force and in which a distance traveled is used to ascertain whether the vehicle brake is malfunctioning;
when the diagnostic step reveals that the vehicle brake is malfunctioning, carrying out a malfunction identification step in which the actuator is controlled in a second direction opposite to the first direction with maximum force and in which a distance traveled is used to ascertain whether the vehicle brake is malfunctioning due to icing; and
when the malfunction identification step reveals a malfunction due to icing, carrying out a deicing step in which the actuator is controlled to move in the first direction with force that is limited compared to the maximum force.

2. The method according to claim 1, wherein, in the diagnostic step, it is determined that there is a malfunction when the distance traveled in the diagnostic step is shorter than a first threshold value.

3. The method according to claim 1, wherein, in the malfunction identification step, it is determined that:
there is a malfunction due to icing when the distance traveled in the malfunction identification step is longer than a second threshold value that is less than the first threshold value, and
there is a malfunction that is not due to icing when the distance traveled in the malfunction identification step is shorter than the second threshold value.

4. The method according to claim 3, wherein, when it is determined that there is a malfunction that is not due to icing, a warning is output and the method is terminated.

5. The method according to claim 1, further comprising: checking after the deicing step whether the distance traveled during the deicing step is longer than the first threshold value.

6. The method according to claim 5, wherein, when it is determined after the deicing step that the distance traveled during the deicing step is shorter than the first threshold value, the malfunction identification step is carried out again.

7. The method according to claim 6, wherein the malfunction identification step and the deicing step are carried out cyclically a predetermined number n1 of times unless one of the following conditions occurs:
during an nth execution of the malfunction identification step, it is determined that the distance traveled during execution of the nth malfunction identification step is shorter than the second threshold value, wherein n is less than or equal to n1, and
after the nth execution of the deicing step it is determined that the distance traveled during execution of the nth deicing step is greater than the first threshold value, wherein n is less than n1.

8. The method according to claim 7, wherein, when, after the n1st execution of the deicing step, it is determined that the distance traveled during execution of the n1st deicing step is shorter than the first threshold value, a warning is output, and the method is terminated.

9. An electromechanical vehicle brake system, comprising:
an electromechanical vehicle brake including: a first brake body, a second brake body, and an electromechanical actuator, wherein the actuator is configured to bring the first brake body into contact with the second brake body to produce a braking effect and to release the first brake body from the second brake body to terminate the braking effect; and
a control device configured to control the electromechanical vehicle brake by performing the following steps including:
carrying out a diagnostic step in which the actuator is controlled to move in a first direction with a force that is limited in comparison to a maximum possible force and in which a distance traveled is used to ascertain whether the vehicle brake is malfunctioning;
when the diagnostic step reveals that the vehicle brake is malfunctioning, carrying out a malfunction identification step in which the actuator is controlled in a second direction opposite to the first direction with maximum force and in which a distance traveled is used to ascertain whether the vehicle brake is malfunctioning due to icing; and
when the malfunction identification step reveals a malfunction due to icing, carrying out a deicing step in which the actuator is controlled to move in the first direction with force that is limited compared to the maximum force.

10. A vehicle, comprising:
an electromechanical vehicle brake system, including:
an electromechanical vehicle brake including: a first brake body, a second brake body, and an electromechanical actuator, wherein the actuator is configured to bring the first brake body into contact with the second brake body to produce a braking effect and to release the first brake body from the second brake body to terminate the braking effect; and
a control device configured to control the electromechanical vehicle brake by performing the following steps including:
carrying out a diagnostic step in which the actuator is controlled to move in a first direction with a force that is limited in comparison to a maximum possible force and in which a distance traveled is used to ascertain whether the vehicle brake is malfunctioning;
when the diagnostic step reveals that the vehicle brake is malfunctioning, carrying out a malfunction identification step in which the actuator is controlled in a second direction opposite to the first direction with maximum force and in which a distance traveled is used to ascertain whether the vehicle brake is malfunctioning due to icing; and
when the malfunction identification step reveals a malfunction due to icing, carrying out a deicing step in which the actuator is controlled to move in the first direction with force that is limited compared to the maximum force.
